(19) United States
(12) Patent Application Publication
(10) Pub. No.: US 2025/0047404 A1
(43) Pub. Date: Feb. 6, 2025

(54) MEASUREMENT SYSTEM AND TIME INFORMATION CORRECTION METHOD THEREOF

(71) Applicant: ANRITSU CORPORATION, Kanagawa (JP)

(72) Inventors: Koji FUKAZAWA, Kanagawa (JP); Hiroyuki TANIKAGE, Kanagawa (JP)

(21) Appl. No.: 18/783,577

(22) Filed: Jul. 25, 2024

(30) Foreign Application Priority Data
Aug. 2, 2023 (JP) 2023-126252

(51) Int. Cl. H04J 3/06; H04W 24/06; H04W 56/00

(52) U.S. Cl. CPC H04J 3/0667; H04W 24/06; H04W 56/001

(57) ABSTRACT

A measurement system is capable of improving the accuracy of a time at a low cost with a simple configuration. A measurement device has a 1PPS signal input unit that receives a 1PPS signal generated by an external signal generation device to output to a PTP time control unit, and a PTP time control unit that performs PTP time control by referring to the 1PPS signal, and a control PC which transmits processing delay prospect information to the PTP time control unit together with time information acquired from an NTP server by an operation performed on an operation unit by a user, in which the PTP time control unit corrects the time information received from the control PC while including the processing delay prospect information by referring to the 1PPS signal, and uses the corrected time information as time information of the PTP.

### TECHNICAL FIELD

The present invention relates to a measurement system that simulates an O-RAN Distributed Unit (O-DU) of an Open-Radio Access Network (O-RAN).

### BACKGROUND ART

In a wireless communication network, as an architecture of a Radio Access Network (RAN) including a base station or the like that is located between a core network and a terminal to perform control on a wireless layer, there is a Centralized Radio Access Network (C-RAN), in which a plurality of wireless units are extended from a baseband processing unit of a base station device that is installed in an aggregated manner and the plurality of wireless units are connected to each other by an optical fiber or the like.

In the C-RAN, there is insufficient standardization for an interface between the baseband processing unit and the wireless units and there are many regions that are individually specified by each vendor, so that it is difficult to realize interconnection between the baseband processing unit and the wireless units of different vendors.

In order to solve such a problem, an O-RAN fronthaul specification has been formulated, and the radio access network is functionally divided into the O-DU as the baseband processing unit and an O-RAN Radio Unit (O-RU) as a wireless unit, and each function is defined.

In the O-RAN fronthaul specification, a Control, User, and Synchronization Plane (C/U/S-Plane) specification that defines details of a device operation and a Management Plane (M-Plane) specification are formulated.

Between the O-DU and the O-RU, high synchronization accuracy is required in order to realize cooperative control based on time synchronization between O-RUs, such as Carrier Aggregation (CA) and Multiple Input Multiple Output (MIMO), using the plurality of O-RUs.

For example, in order to establish a connection between a mobile machine and a base station, high synchronization accuracy is essential for the calculation of System Frame Number (SFN) required by an O-RAN standard (O-RAN.WG4.CUS (v11 Sec.11.7.2)).

In the O-RAN fronthaul specification, as the S-Plane, Precision Time Protocol (PTP) and Synchronous Ethernet (SyncE, registered trademark), which are protocols for realizing high synchronization accuracy on an O-RU side by synchronizing with a clock on a high-performance O-DU side, are supported.

Patent Document 1 discloses that a process related to synchronization is appropriately executed based on a synchronization signal by disposing an apparatus, which evaluates a first reference signal by comparing the first reference signal restored using a synchronization signal received from an O-DU with a second reference signal generated from a time signal acquired from satellites constituting a Global Navigation Satellite System (GNSS), and generates a new synchronization signal based on a result of the evaluation and transmits the new synchronization signal to the O-RU, between the O-DU and the O-RU.

### RELATED ART DOCUMENT

### Patent Document

[Patent Document 1] JP-A-2022-40947

### DISCLOSURE OF THE INVENTION

### Problem that the Invention is to Solve

As described in Patent Document 1, it is considered to receive a time signal from satellites constituting the GNSS in order to increase synchronization accuracy. However, in a case where a GNSS receiver is included in the configuration of as measurement device, the configuration becomes complicated, so that the configuration of the measurement system becomes large and the cost is also increased.

In addition, in a case where a Network Time Protocol (NTP) is used for time synchronization, the accuracy is as bad as about millisecond units, and delays in the apparatus also should be taken into consideration.

As described above, there is a problem in that the acceptance criteria of the time accuracy as the measurement device cannot be met as specified in the O-RAN standard.

Therefore, an object of the present invention is to provide a measurement system capable of improving the time accuracy at a low cost with a simple configuration.

### Means for Solving the Problem

According to the present invention, there is provided a measurement system including a measurement device that simulates an O-RAN Distributed Unit (O-DU) of an Open-Radio Access Network (O-RAN), and an external device that executes a measurement by controlling the measurement device, in which the measurement device includes a Precision Time Protocol (PTP) time control unit that performs PTP time control with an O-RAN Radio Unit (O-RU) of the O-RAN, the external device transmits, to the PTP time control unit, processing delay prospect information which includes a preset processing delay time generated in a case of transmitting information from the external device to the PTP time control unit, and time information which is acquired from a Network Time Protocol (NTP) server, and the PTP time control unit refers to a 1 Pulse Per Second (1PPS) signal input from an outside, corrects the time information, which is received from the external device while including the processing delay prospect information, and uses the corrected time information as time information of the PTP.

With this configuration, the time information acquired from the NTP server is corrected while including the processing delay prospect information by referring to 1PPS signal input from the outside, and is used as the time information of the PTP. Therefore, the time accuracy can be improved at a low cost with a simple configuration.

In addition, the measurement system according to the present invention further includes a System Frame Number (SFN) calculation unit that calculates an SFN based on the time information of the PTP, in which the calculated SFN is stored as an information element in a communication packet with the O-RU.

In addition, according to the present invention, there is provided a time information correction method of a measurement system including a PTP time control unit that performs PTP time control with an O-RU of an O-RAN, a measurement device that simulates an O-DU of the O-RAN, and an external device that executes a measurement by controlling the measurement device, the time information correction method including a step of the external device transmitting, to the PTP time control unit, processing delay prospect information which includes a preset processing delay time generated in a case of transmitting information from the external device to the PTP time control unit, and time information which is acquired from an NTP server, and a step of the PTP time control unit referring to a 1PPS signal input from an outside, correcting the time information, which is received from the external device while including the processing delay prospect information, and using the corrected time information as time information of the PTP.

With this configuration, the time information acquired from the NTP server is corrected while including the processing delay prospect information by referring to 1PPS signal input from the outside, and is used as the time information of the PTP. Therefore, the time accuracy can be improved at a low cost with a simple configuration.

In addition, the time information correction method according to the present invention further includes calculating a System Frame Number (SFN) based on the time information of the PTP and storing the calculated SFN as an information element in a communication packet with the O-RU.

### Advantage of the Invention

The present invention can provide a measurement system capable of improving the time accuracy at a low cost with a simple configuration.

### BRIEF DESCRIPTION OF THE DRAWINGS

FIG. 1 is a block diagram of a measurement system according to an embodiment of the present invention.

FIG. 2 is a diagram showing an example of a GNSS time setting button of the measurement system according to the embodiment of the present invention.

### BEST MODE FOR CARRYING OUT THE INVENTION

Hereinafter, a measurement system according to an embodiment of the present invention will be described in detail with reference to the drawings.

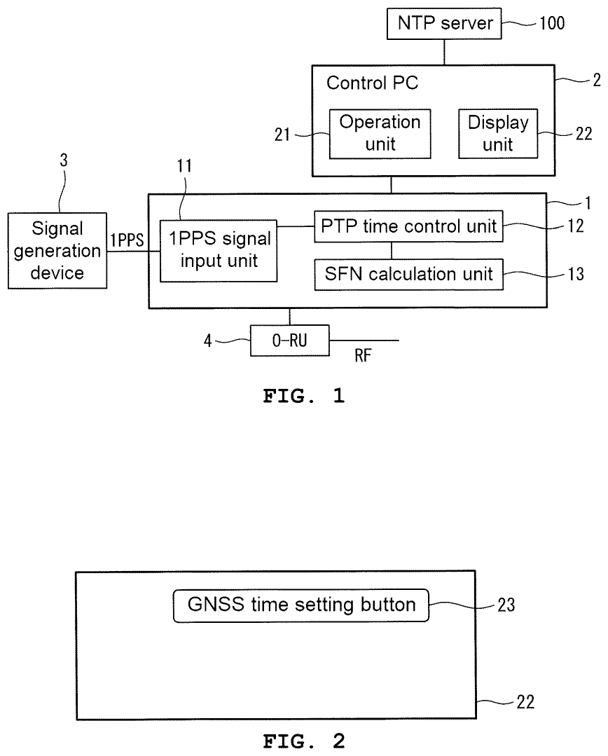

In FIG. 1, the measurement system according to the embodiment of the present invention includes a measurement device 1 and a control PC 2 as an external device.

The measurement device 1 is connected to the control PC 2 and is operated under the control of the control PC 2. A function of the control PC 2 may be incorporated into the measurement device 1 to form an integrated measurement device 1.

The measurement device 1 is composed of, for example, a computer unit that includes a Central Processing Unit (CPU), a Random Access Memory (RAM), a Read Only Memory (ROM), a flash memory, a hard disk device, an input port, and an output port.

In the computer unit, for example, the CPU executes an Operating System (OS) stored in the hard disk device, so that the CPU can control devices connected to the input port and the output port.

The measurement device 1 includes a 1PPS signal input unit 11, a PTP time control unit 12, and an SFN calculation unit 13.

The 1PPS signal input unit 11 receives a 1Pulse Per Second (1PPS) signal generated by an external signal generation device 3 and outputs the 1PPS signal to the PTP time control unit 12.

The PTP time control unit 12 performs PTP time control by referring to the 1PPS signal from the 1PPS signal input unit 11.

The control PC 2 is composed of, for example, a computer unit that includes the CPU, the RAM, the ROM, the flash memory, the hard disk device, the input port, the output port, an operation unit 21, and a display unit 22.

The operation unit 21 is composed of, for example, input devices such as a keyboard, a mouse, and a touch panel, and outputs information and the like, which is input for the operation, to the CPU.

The display unit 22 is composed of, for example, an image display device such as a liquid crystal display, and displays an image for inputting information necessary for setting a test, an image showing a state during the test, and the like.

In the computer unit, the CPU executes the OS stored in the hard disk device, such that the CPU can control a device connected to the input port and the output port.

The control PC2 acquires time information from an NTP server 100 that distributes the time information by the NTP.

The control PC2 stores processing delay prospect information in a case of transmitting information to the PTP time control unit 12. The processing delay prospect information is total processing delay prospect information generated in the control PC 2 and the PTP time control unit 12. The processing delay prospect information includes at least any of a fixed processing delay that is obtained in advance as a hardware specific between the control PC 2 and the PTP time control unit 12, or a processing delay that varies according to an actually measured processing load of each hardware of the control PC 2 and the PTP time control unit 12. The actual measurement may be performed by, for example, calculating a time difference between a time of the GNSS and a state without uncorrected processing delay prospect. The GNSS is, for example, a global positioning system (GPS), GLONASS, BeiDou, Galileo, guidance, or the like.

In a case where a time setting function is selected by an operation of a user on the operation unit 21, the control PC2 displays, for example, as shown in FIG. 2, a GNSS time setting button 23 on the display unit 22.

In a case where the GNSS time setting button 23 is selected by the operation of the user on the operation unit 21, the control PC 2 transmits the processing delay prospect information to the PTP time control unit 12 together with the time information acquired from the NTP server 100.

The PTP time control unit 12 corrects the time information received from the control PC 2 while including the processing delay prospect information by referring to the 1PPS signal from the 1PPS signal input unit 11, and uses the corrected time information as the time information of the PTP.

In order to establish a connection between a mobile machine and a base station, the SFN calculation needs to be performed based on correct time information. The SFN calculation unit 13 calculates the SFN based on the time information of the PTP. The calculated SFN is stored as an information element in a communication packet with O-RU4.

As described above, in the above-described embodiment, the control PC2 stores the processing delay prospect information in a case of transmitting the information to the PTP time control unit 12, and transmits the processing delay prospect information to the PTP time control unit 12, together with the time information acquired from the NTP server 100, in a case where the GNSS time setting button 23 is selected by the operation of the user on the operation unit 21. The PTP time control unit 12 corrects the time information received from the control PC 2 while including the processing delay prospect information by referring to the 1PPS signal from the 1PPS signal input unit 11, and uses the corrected time information as the time information of the PTP.

As a result, the time information acquired from the NTP server 100 is corrected while including the processing delay prospect information by referring to the 1PPS signal. Therefore, the time accuracy can be improved at a low cost with a simple configuration. Therefore, in order to establish the connection between the mobile machine and the base station, the SFN can be calculated based on correct time information.

Although an embodiment of the present invention has been disclosed, it will be apparent that modifications may be made by those skilled in the art without departing from the scope of the present invention. All such modifications and equivalents are intended to be included in the following claims.

### DESCRIPTION OF REFERENCE NUMERALS AND SIGNS

1 Measurement Device
2 Control PC (External Device)
3 Signal Generation Device
4 O-RU
11 1PPS Signal Input Unit
12 PTP Time Control Unit
13 SFN Calculation Unit
21 Operation Unit
22 Display Unit
23 GNSS Time Setting Button
100 NTP Server

What is claimed is:

1. A measurement system comprising:
a measurement device that simulates an O-RAN Distributed Unit (O-DU) of an Open-Radio Access Network (O-RAN); and
an external device that executes a measurement by controlling the measurement device, wherein
the measurement device includes a Precision Time Protocol (PTP) time control unit that performs PTP time control with an O-RAN Radio Unit (O-RU) of the O-RAN,
the external device transmits, to the PTP time control unit, processing delay prospect information which includes a preset processing delay time generated in a case of transmitting information from the external device to the PTP time control unit, and time information which is acquired from a Network Time Protocol (NTP) server, and
the PTP time control unit refers to a 1Pulse Per Second (1PPS) signal input from an outside, corrects the time information, which is received from the external device based on the 1PPS signal and the processing delay prospect information, and uses the corrected time information as time information of the PTP.

2. The measurement system according to claim 1, further comprising:
a System Frame Number (SFN) calculation unit that calculates an SFN based on the time information of the PTP, wherein
the calculated SFN is stored as an information element in a communication packet with the O-RU.

3. A time information correction method of a measurement system including a PTP time control unit that performs PTP time control with an O-RU of an O-RAN, a measurement device that simulates an O-DU of the O-RAN, and an external device that executes a measurement by controlling the measurement device, the time information correction method comprising:
a step of the external device transmitting, to the PTP time control unit, processing delay prospect information which includes a preset processing delay time generated in a case of transmitting information from the external device to the PTP time control unit, and time information which is acquired from an NTP server, and
a step of the PTP time control unit referring to a 1PPS signal input from an outside, correcting the time information, which is received from the external device while including the processing delay prospect information, and using the corrected time information as time information of the PTP.

4. The time information correction method according to claim 3, further comprising:
calculating a System Frame Number (SFN) based on the time information of the PTP and storing the calculated SFN as an information element in a communication packet with the O-RU.
